(19) United States
(12) Patent Application Publication
(10) Pub. No.: US 2026/0126178 A1
(43) Pub. Date: May 7, 2026

(54) Control Knob For Cooking Appliance

(71) Applicant: Midea Group Co., Ltd., Foshan (CN)

(72) Inventor: Weiqun Yang, Middleton, WI (US)

(73) Assignee: Midea Group Co., Ltd., Foshan (CN)

(21) Appl. No.: 18/934,985

(22) Filed: Nov. 1, 2024

(51) Int. Cl. F24C 3/12; G05G 1/08; G05G 5/00

(52) U.S. Cl. CPC F24C 3/126; G05G 1/082; G05G 5/005; G05G 2505/00

(57) ABSTRACT

A method and apparatus of a control knob for a cooking appliance. The control knob includes a safety feature for operating one or more heating elements of the cooking appliance.

### BACKGROUND OF THE INVENTION

In appliance manufacturing industries generally, and specifically in the range or cooking appliance manufacturing industries, most appliances such as cooktops or ranges have a variety of control or selector knobs for adjusting and controlling the amount of heat supplied to the various appliance burners or heating elements. Typically, these knobs are easily accessible to the average user, thereby making them simple and quick to operate, but also providing ready access to children and others lacking the requisite judgment to safely operate the appliance.

In order to provide a measure of safety to oven and cooktop appliances, manufacturers have equipped some control knobs and selectors with simple lockout mechanisms. For example, some control knobs are mounted on spring-loaded shafts that require a user to push or depress the knob slightly before it will turn (e.g. push and turn), thereby providing at least a small measure of child-safety lockout protection. Gas appliances are typically equipped with these push-unlock valves as a mechanism to prevent accidental valve operation but they do not offer a reliable safety lockout mechanism.

Household cooking gas appliances in the United States are certified to the ANSI Z21.1 standard. This standard states that “Any manual gas valve or energy controlling device intended for use during normal operation and that has an off position to shut off the gas to a main burner or the energy flow to a heating/cooking element shall necessitate not less than two separate manual operations to turn on and shall necessitate only one manual operation to turn off.” Typically, many standard manual gas valves are made to open from the closed position by first pushing in and then turning (e.g. push and turn along the rotational/longitudinal axis), for example. Further, appliances may utilize “digital” gas valves wherein a control knob is connected or secured to an electrical component, for example a resolver or encoder, that then translates the rotational position of the valve into an electrical signal representative of desired valve positioned to an electrically actuated gas valve to control the burner. In the case of these digital valves may be made to open from the closed position by first pushing in and then turning (e.g. push and turn, two manual operations), for example, in order to provide safe operation of the valves and concomitant burners.

Various child lockout systems have been provided in the industry, with varying degrees of safety and operability. There does not exist, however, a reliable system for providing child safety control to an appliance that simultaneously provides ease of access and use for an adult user and permits a user to configure the operation of the burner and valve.

From the foregoing it can readily be seen that there is a need in the art for a control/actuator system (e.g. valve, gas valve, digital valve, electric, gas, both gas and electric) that utilizes an initiation process, for example an initiation process and concomitant knob or actuator that can be employed with individual appliances to control the heating/cooking elements (e.g. electric, gas, both) of the appliance.

### SUMMARY OF THE INVENTION

In some embodiments, a cooking appliance may include one or more heating elements. In various embodiments, the appliance may include a push and turn actuator configured to operate the one or more heating elements. In some embodiments, the appliance may include a control knob having one or more protrusions. In various embodiments, the appliance may include a knob shaft slidably connected to the control knob, wherein the knob shaft may include one or more latching docks. In some embodiments, the appliance may include a biasing mechanism between the knob shaft and the control knob. In various embodiments, the control knob may be positionable between a first configuration and a second configuration relative to the knob shaft, wherein when in the first configuration the one or more protrusions may be disengaged from the one or more latching docks whereby the biasing mechanism urges the control knob and the one or more protrusions in a first direction along a longitudinal axis away from the knob shaft and one or more latching docks towards the push and turn actuator, and wherein when in the second configuration the one or more protrusions may be engaged to the one or more latching docks whereby the biasing mechanism urges the one or more protrusions in the first direction into engagement with the one or more latching docks towards the push and turn actuator. In some embodiments, when in the second configuration the control knob may be configured to push the knob shaft and push and turn actuator in the first direction and rotate the knob shaft and push and turn actuator in at least one rotational direction about the longitudinal axis.

In addition, in some embodiments, the one or more protrusions may be an axially projecting rib axially engaging one or more axial slots in a third configuration and axially disengaging the one or more axial slots in a fourth configuration. In various embodiments, the control knob may include a collar, wherein the collar includes the one or more axial slots. In some embodiments, the one or more protrusions may be a radially projecting rib radially engaging a first end of one or more longitudinal extending slots when in the first configuration and an opposing second end of the one or more longitudinal extending slots when in the second configuration, and wherein the one or more latching docks may be adjacent the opposing second end of the one or more longitudinal extending slots. In various embodiments, the knob shaft may include the one or more longitudinal extending slots. In some embodiments, the one or more longitudinal extending slots may be helical in shape about the longitudinal axis. In various embodiments, the biasing mechanism may urge the control knob rotationally about the longitudinal axis. In some embodiments, the control knob may include a knob body and a shaft bracket, wherein the knob shaft may be slidably positioned between the knob body and the shaft bracket, and wherein the one or more protrusions axially project from the knob body or radially project from the shaft bracket.

In some embodiments, a control knob for a cooking appliance may include a knob body having one or more protrusions. In various embodiments the control knob may include a knob shaft having one or more latching docks. In some embodiments, the control knob may include a biasing mechanism between the knob body and the knob shaft. In some embodiments, the knob body may be positionable between a first configuration and a second configuration relative to the knob shaft, wherein when in the first configuration the one or more protrusions may be disengaged from the one or more latching docks whereby the biasing mechanism urges the knob body and the one or more protrusions in a first direction along a longitudinal axis away from the knob shaft and one or more latching docks, and wherein when in the second configuration the one or more protrusions may be engaged to the one or more latching docks whereby the biasing mechanism may urge the one or more protrusions in the first direction into engagement with the one or more latching docks. In various embodiments, when in the second configuration the knob body may be configured to push the knob shaft and push and turn actuator in the first direction and rotate the knob shaft and push and turn actuator in at least one rotational direction about the longitudinal axis.

In addition, in some embodiments, wherein the one or more protrusions may be an axially projecting rib axially engaging one or more axial slots in a third configuration and axially disengaging the one or more axial slots in a fourth configuration. In various embodiments, the control knob may include a collar, wherein the collar may include the one or more axial slots. In some embodiments, the one or more protrusions may be a radially projecting rib radially engaging a first end of one or more longitudinal extending slots when in the first configuration and an opposing second end of the one or more longitudinal extending slots when in the second configuration, wherein the one or more latching docks may be adjacent the opposing second end of the one or more longitudinal extending slots. In some embodiments, the knob shaft may include the one or more longitudinal extending slots. In various embodiments, the one or more longitudinal extending slots may be helical in shape about the longitudinal axis. In some embodiments, the biasing mechanism may urge the control knob rotationally about the longitudinal axis.

In some embodiments, a method of activating one or more heating elements of a cooking appliance may include providing a push and turn actuator with a knob shaft connected thereto, wherein the knob shaft may include one or more latching docks. In various embodiments, the method may include providing a control knob having one or more protrusions. In some embodiments, the method may include axially moving the control knob in a second direction along a longitudinal axis away from the push and turn actuator. In various embodiments, the method may include rotating the control knob relative to the knob shaft to engage the one or more protrusions of the control knob to the one or more latching docks of the knob shaft. In some embodiments, the method may include pushing in a first direction opposite to the second direction along the longitudinal axis and rotating the control knob and the knob shaft after rotating the control knob to engage the one or more protrusions to the latching docks to operate the push and turn actuator to a predetermined position representative of a desired output level of one or more heating elements.

In addition, in some embodiments, the method may include converting rotatory motion to axially move the control knob in the second direction wherein rotating the control knob relative to the knob shaft. In various embodiments, the method may include axially disengaging one or more axially projecting ribs from one or more axial slots when axially moving the control knob in the second direction. In some embodiments, the method may include preventing axially movement of the control knob in the first direction when the one or more protrusions are disengaged from the one or more latching docks. In various embodiments, the method may include biasing the control knob in first second direction along the longitudinal axis and/or rotationally about the longitudinal axis.

It should be appreciated that all combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. The drawings are not necessarily to scale. Emphasis is instead generally placed upon illustrating the principles of the disclosure, wherein;

FIG. 1 is a perspective view of a gas appliance having a plurality of control knobs in accordance with various embodiments;

FIG. 2 is a rear perspective view of a control knob illustrating a locked or first configuration and/or a third configuration in accordance with various embodiments;

FIG. 3 is a sectional view of the control knob of FIG. 2;

FIG. 4 is a sectional view of the control knob of FIG. 2 with a collar broken away illustrating the first configuration and/or a fourth configuration in accordance with various embodiments;

FIG. 5 is a sectional view of the control knob of FIG. 2 with a collar broken away illustrating the second configuration and/or fourth configuration in accordance with various embodiments;

FIG. 6 is a rear perspective view of the control knob of FIG. 5;

FIG. 7 is an exploded view of the control knob of FIG. 2;

FIG. 8A is a side sectional view of FIG. 2;

FIG. 8B is a sectional view taken along line 8B-8B of FIG. 8A;

FIG. 9A is a side sectional view of FIG. 4;

FIG. 9B is a sectional view taken along line 9B-9B of FIG. 9A;

FIG. 10A is a side sectional view of FIGS. 5 and 6;

FIG. 10B is a sectional view taken along line 10B-10B of FIG. 10A;

FIG. 11 is a rear perspective view of another embodiment of a control knob illustrating a locked or first configuration in accordance with various embodiments;

FIG. 12 is a sectional view of the control knob of FIG. 11;

FIG. 13 is an exploded view of the control knob of FIG. 11;

FIG. 14 is a sectional view of the control knob of FIG. 12;

FIG. 15 is a sectional view of the control knob of FIG. 11 illustrating the second configuration in accordance with various embodiments;

FIG. 16 is another sectional view of the control knob of FIG. 15 activating a push and turn actuator.

### DETAILED DESCRIPTION OF THE INVENTION

Numerous variations and modifications will be apparent to one of ordinary skill in the art, as will become apparent from the description below. Therefore, the invention is not limited to the specific implementations discussed herein.

The embodiments discussed hereinafter will focus on the implementation of the hereinafter-described techniques and apparatuses within a residential cooking appliance such as cooking appliance 10, such as the type that may be used in single-family or multi-family dwellings, or in other similar applications. However, it will be appreciated that the herein-described techniques and apparatuses may also be used in connection with other types of cooking appliances in some embodiments. For example, the herein-described techniques may be used in commercial applications in some embodiments. Moreover, the herein-described techniques may be used in connection with various cooking appliance configurations. Implementation of the herein-described techniques within gas/electric top burner(s), oven burner, broil burner, gas/electric range, gas/electric slide-in oven, freestanding oven, gas/electric cooktop, gas/electric countertop range, etc. would be well within the abilities of one of ordinary skill in the art having the benefit of the instant disclosure, so the embodiments, are not limited to the freestanding oven implementations using a manual/electric gas valve, switch, or actuator (e.g. push and turn). Although the actuator may be a push and turn as shown in the embodiments, the actuator may only require rotation or another type of operation(s) and still be within the scope of the invention. Moreover, the herein-described techniques may be used in manual and/or electronic controls/valves/actuators/switches or other applications with controls such as, but is not limited to, gas/electric furnaces, gas/electric water heaters, gas/electric fireplaces/logs, and gas/electric space heaters. Although the gas valve 17 and/or actuator 16 of the valve is a push and turn (e.g. along the rotational/longitudinal axis A) as shown, it should be understood that a switch (e.g. electrical, mechanical, both, used for an electrical heating element) and/or actuator 16 of the switch or device may be a push and turn and still be within the scope of the invention.

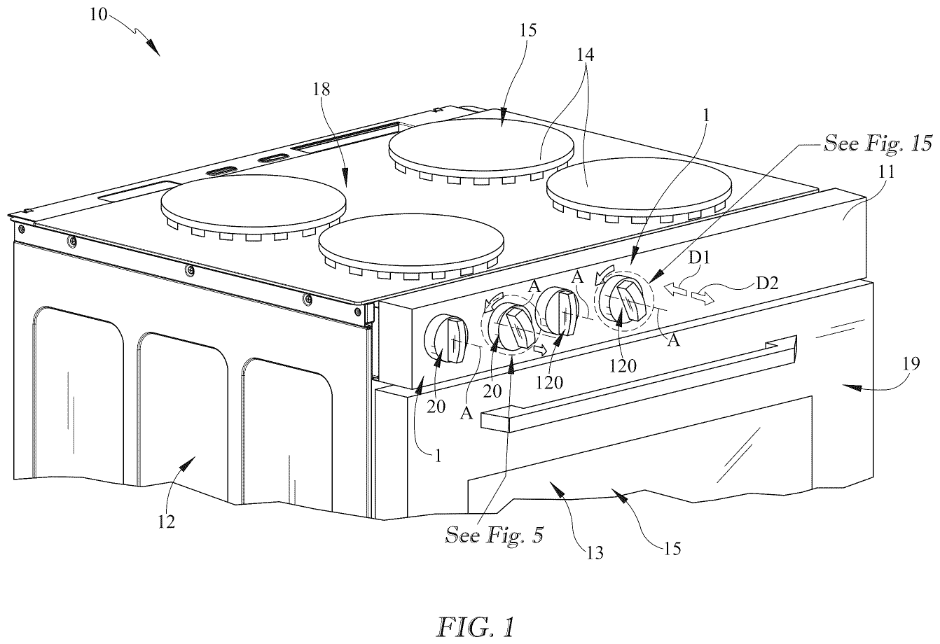

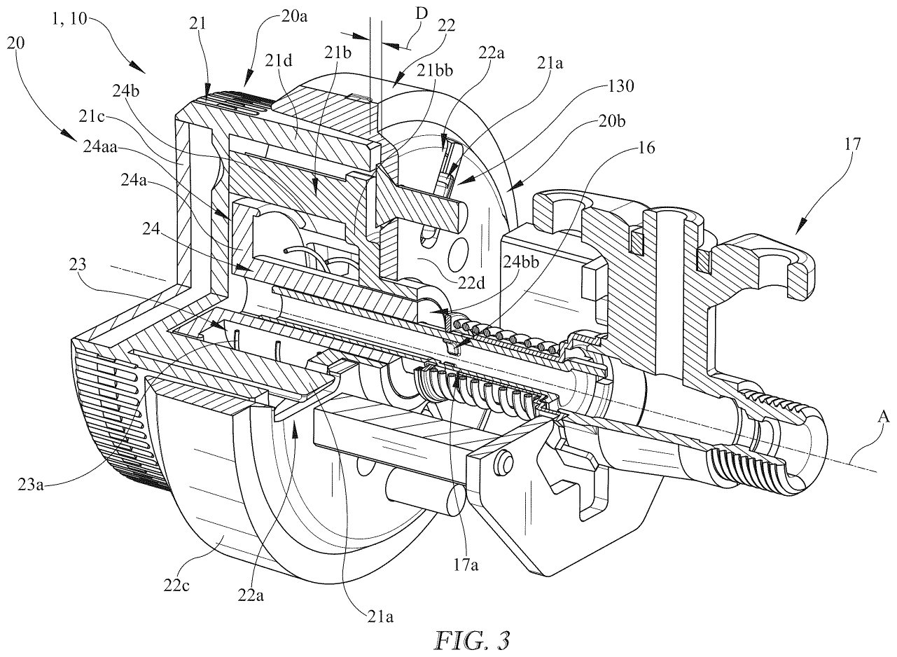

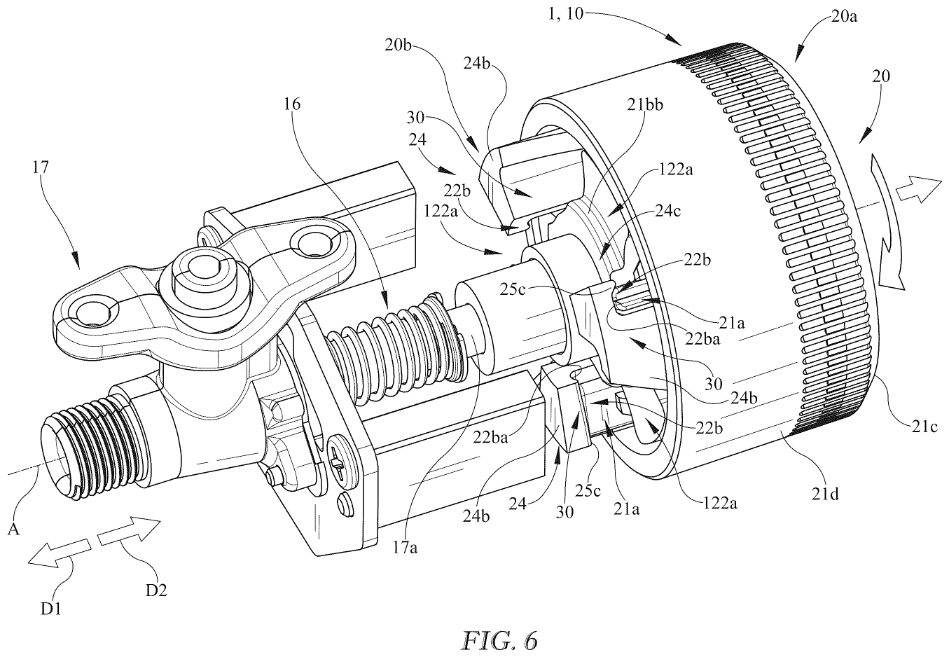

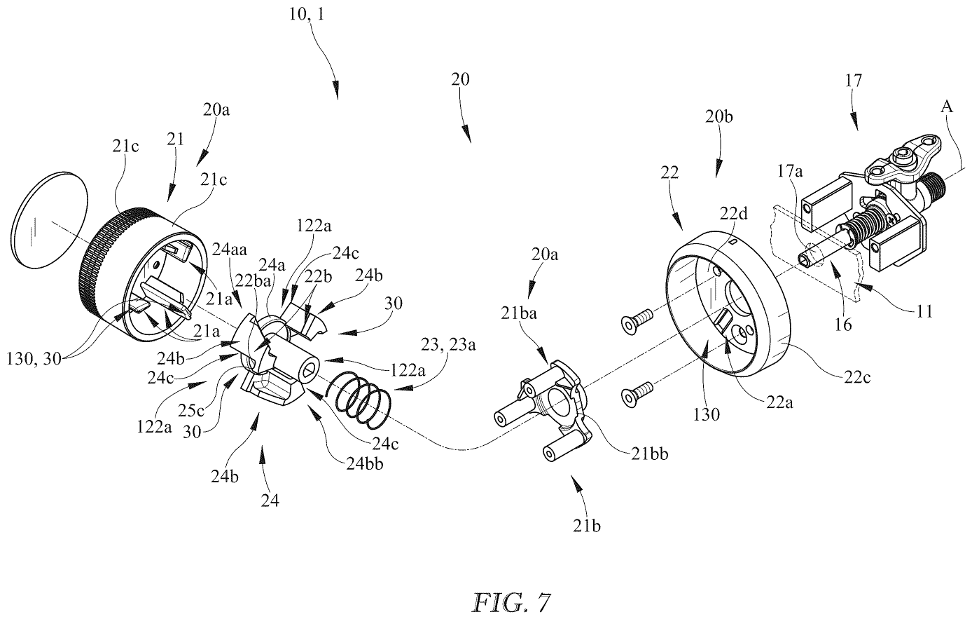

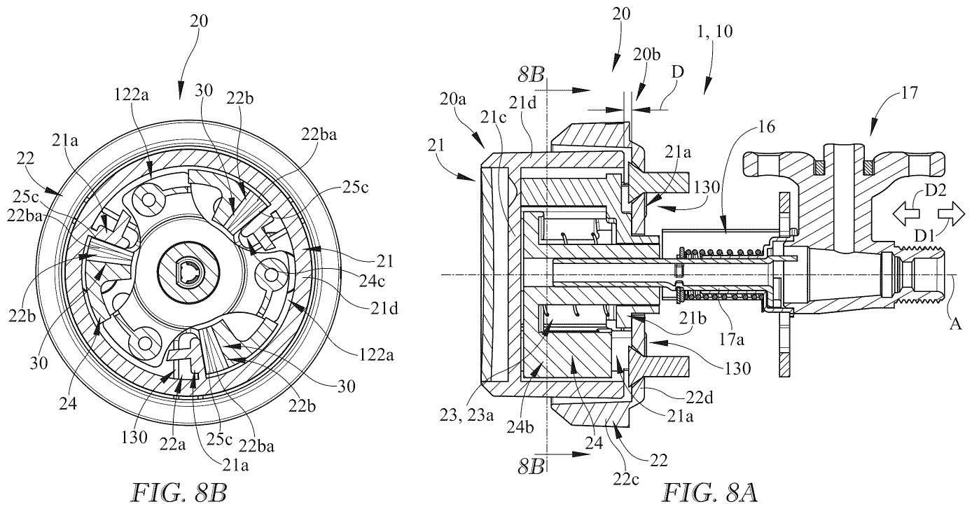

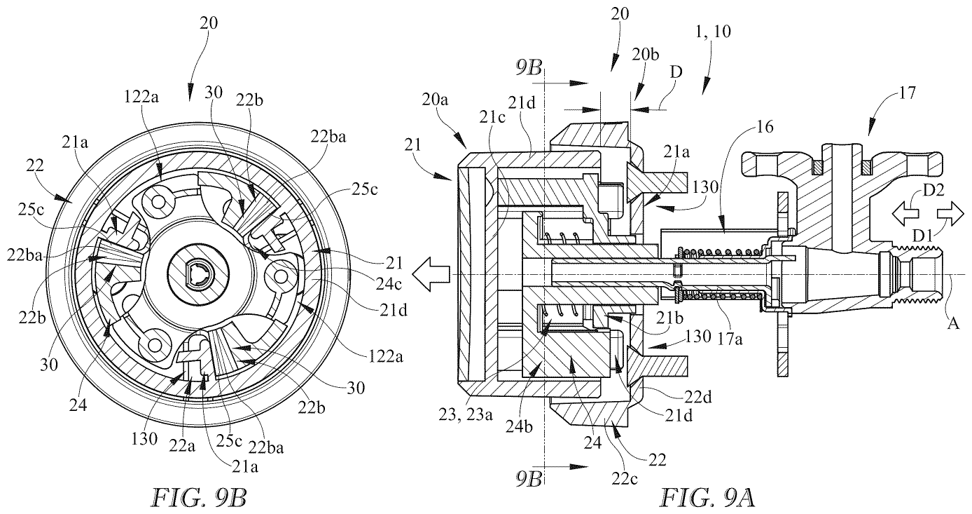

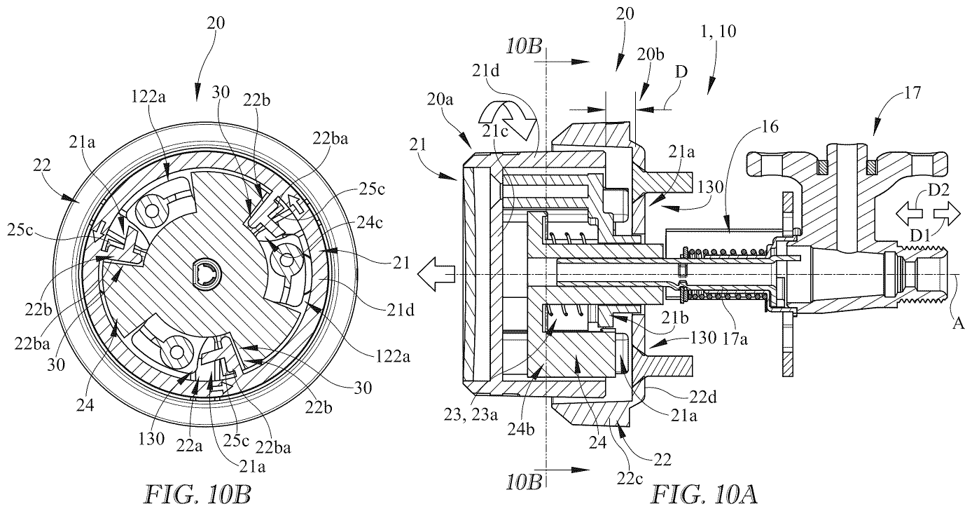

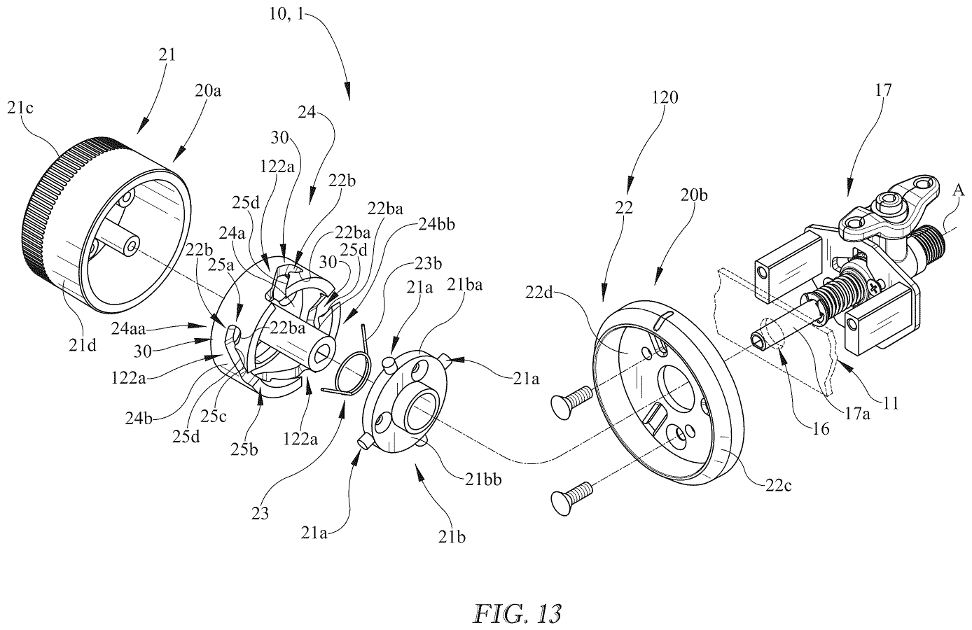

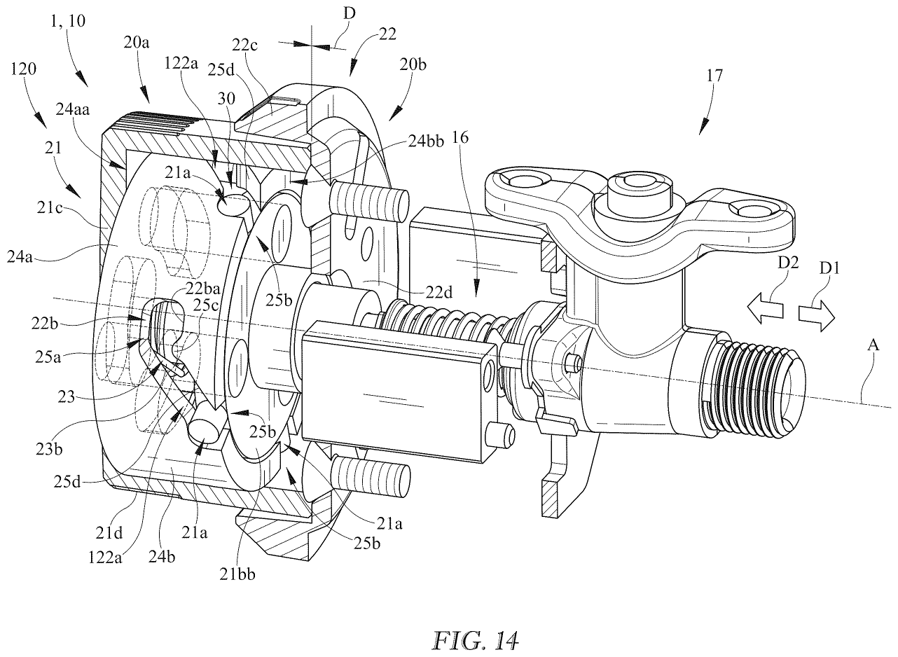

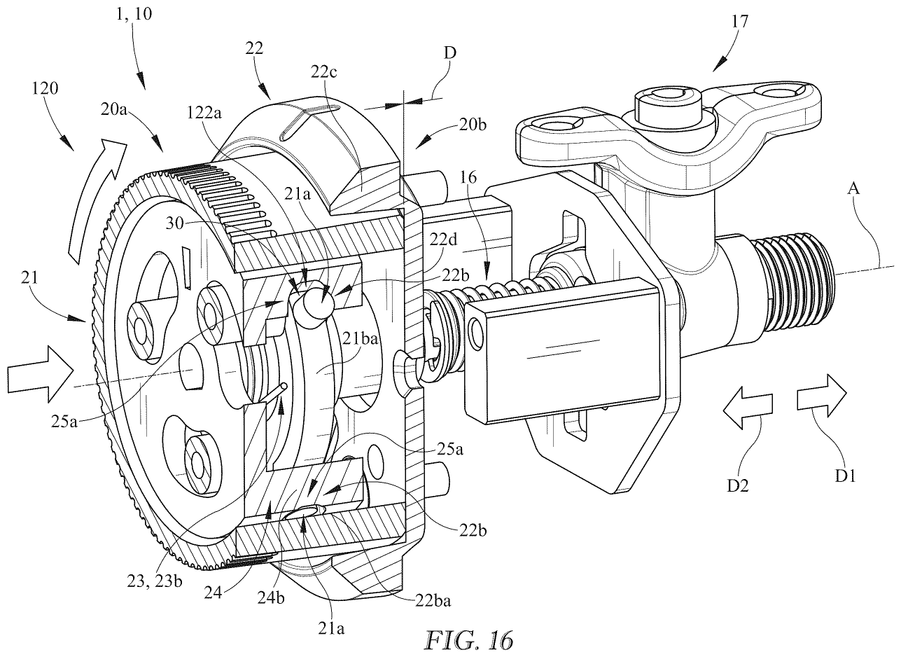

As shown in the Figures, one or more controls (e.g. control knobs 20) may be used within a home cooking appliance 10, such as but not limited to a freestanding cooking range, has a housing 12 and a cooking compartment 13, such as a baking oven, convection oven, steam oven, warming drawer and the like, in the housing 12 and accessible through a door or drawer. In the embodiment shown, the appliance 10 is a gas range, with the manual control knob(s) 20 (e.g. gas control knob, rotatable, push and turn) operating one or more gas valve(s) 17, if used, in fluid communication with at least one downstream gas burner 14 (e.g. cooktop surface 18 and/or cooking compartment 13) via channels/tubes. Although a gas control knob is shown in the embodiment, an electrical gas control knob or electrical and gas control knob may be used. It should be understood that the actuators 16/valves 17 may be electronically/mechanically/electromechanically controlled remotely from the controls/knobs in some embodiments. The gas valve 17 may engage at least one gas manifold in fluid communication with the gas, liquid, or fuel supplied to the appliance 10. The appliance 10 includes a cooktop surface 18 on a top of the housing 12. In some implementations, the manual gas valves 17 may be positioned within a control panel 11 (e.g. front control panel, rear control panel, etc.) within the cooking appliance 10 and have a plurality of control knobs or controls 20 for controlling/operating the heating elements 15 (e.g. gas, electric, or both), actuator 16, the gas burners 14, manual gas valves 17, gas/electric burner characteristics, and/or cooking compartment, etc. The valve 17 or actuator 16 (e.g. operating a device/valve by a push and turn) may be operable between a closed configuration (see FIGS. 1-15) wherein the fuel/power is not in communication with the one or more burners 14 or heating elements 15 and an open configuration (e.g. push and turn, see FIG. 16) wherein the fuel/power is in communication with the one or more burners 14 or heating element 15. Although a front control panel 11 below the cooktop surface 18 on the front 19 of the housing 12 is shown in the one embodiment, it should be understood that the control panel and/or knob(s) 20 may be of a variety of positions relative to the housing, shapes, sizes, quantities, and constructions and still be within the scope of the invention.

Referring to the Figures, and in accordance with some embodiments, a system 1 (e.g. safety mechanism, locking mechanism) for implementing an actuator 16 (e.g. gas valve 17, electrical, mechanical, electromechanical, push/press and turn, two-step, switch) for an appliance 10 includes one or more control or selector knobs 20, that are utilized to operate the actuator 16 of appliance 10 and/or heating element(s) 15. In the one embodiment shown, the actuator 16 (e.g. push and turn) operates a push/press and turn valve (e.g. gas valve 17). It should be understood that any appliance 10, actuator 16, or other device (e.g. push and turn) that utilizes control or selector knobs 20 wherein it would be desirable to implement an initiation process (e.g. one or more steps) may be implemented as part of system 1 without departing from the scope of the invention.

In one non-limiting exemplary embodiment for purposes of illustration in this specification, appliance 10 may be a conventional gas stove 10, (or equivalently a cooktop and oven combination). Stove 10 may include multiple control knobs 20, for example control knobs to adjust the flow of gas to a plurality of actuators 16 (e.g. gas valves 17), and thus the heat output of a plurality of heating elements 15 (e.g. cooktop burners 14), as well as a plurality of oven heating elements or burners (not shown). In some aspects appliance 10 may include only one control knob that is assigned to individual actuators 16/valves 17 and concomitant burners 14. Other control knobs 20 for adjusting or operating various appliance 10 controls may also be present, but for purposes of explication have been omitted from this example. In one exemplary but non-limiting embodiment that will be used throughout this specification for purposes of explication, the control knobs 20 may be assumed to operate a plurality of actuators 16/gas valves 17, for example valves 17 supplying gas cooktop burners 14 and/or gas oven burners. In some aspects and embodiments control knobs 20 are turned or rotated clockwise to supply additional gas (and therefore heat) to a selected burner 14, and conversely turned counter-clockwise to reduce the amount of gas (and therefore heat) to a selected burner 14. In some aspects and embodiments control knobs may be rotated in a first rotational direction to increase the open position of valve 17 and rotated in the opposite rotational direction to reduce the open position of valve 17.

In accordance with some aspects of the system 1 provides a methods and apparatus for implementing an initiation process before turning on the actuator 16, gas valve 17, or device (e.g. push and turn) and/or heating elements 15. In one exemplary embodiment appliance 10 includes at least one control knob 20 for setting a desired switch/valve 17 position, or alternatively burner 14 power level. Throughout the specification gas valve 17 position and burner 14 power level and/or heat level will be referred to interchangeably. It should be understood that the position of a specified gas valve 17 or switch will dictate the power level and/or heat level of that burner 14.

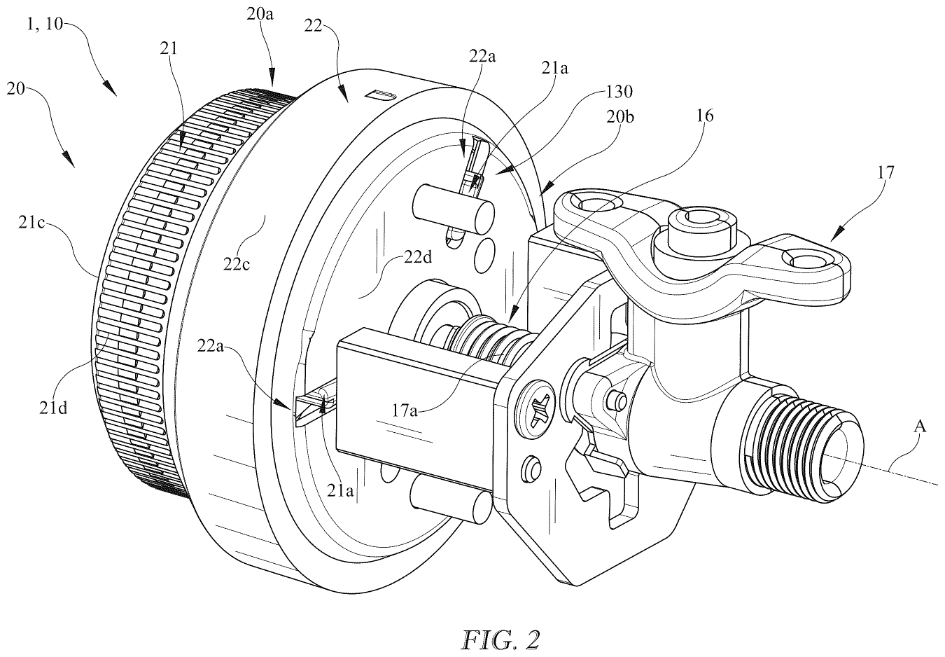

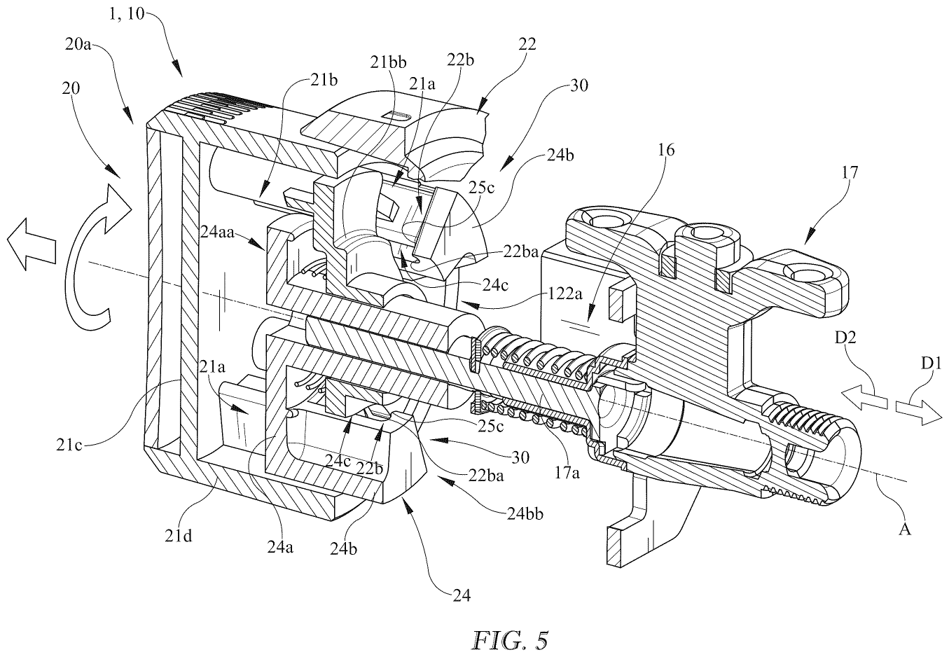

In some implementations, the initiation process may include a pull and turn of the control knob 20 from the inoperable position (e.g. no push and/or turn operation) of actuator 16 to the operable position of the actuator 16 whereby the push and turn operation may be used to operate the heating elements 15. One embodiment of the pull and turn control knob 20 or system 1 is shown in FIGS. 1-10. The push and/or turn of the actuator 16 via the control knob 20 may not be operated in the inoperable position shown in FIGS. 2-4, 8A, 8B, 9A, and 9B. The push and turn of the actuator 16 via the control knob 20 may be operated in the operable position shown in FIGS. 5, 6, 10A, and 10B.

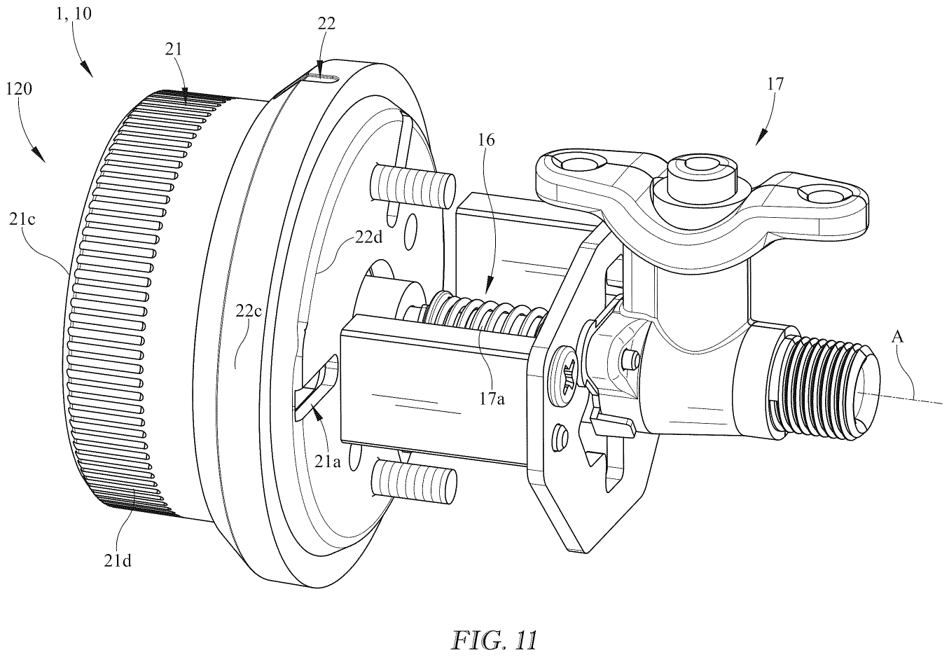

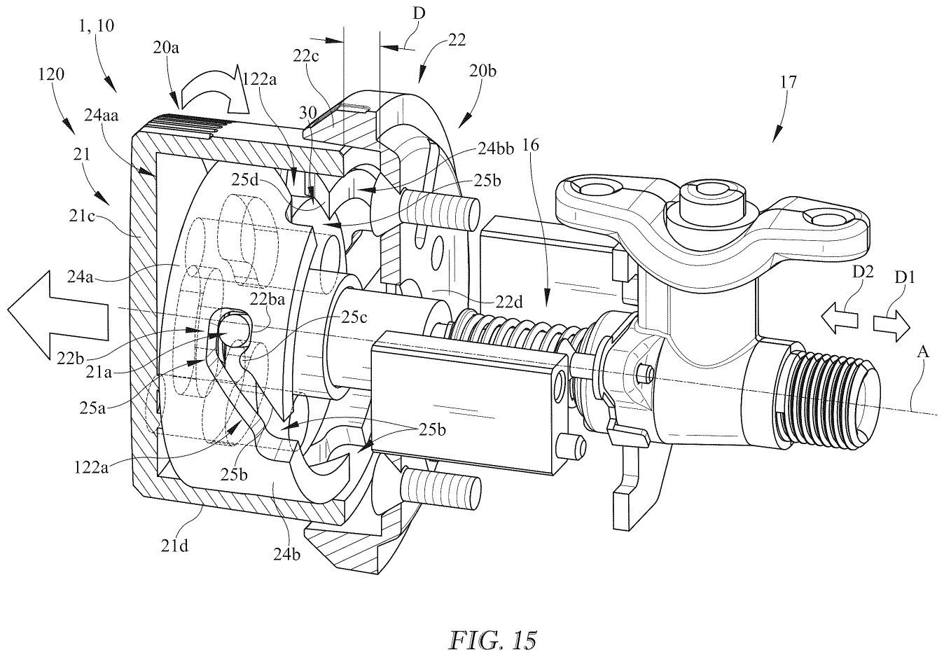

In some implementations, the initiation process may include a turn of the control knob 120 from the inoperable position (e.g. no push and/or turn operation) of actuator 16 to the operable position of the actuator 16 whereby the push and turn operation may be used to operate the heating elements 15. One embodiment of the turn control knob 120 or system 1 is shown in FIGS. 1 and 11-16. Although the pull action may not be needed, the user may pull and turn the control knob 120 away from the control panel 11 or push and turn actuator 16 in some embodiments and still be within the scope of the invention. The push and/or turn of the actuator 16 via the control knob 120 may not be operated in the inoperable position shown in FIGS. 11, 12, and 14. The push and turn of the actuator 16 via the control knob 120 may be operated in the operable position shown in FIGS. 15 and 16.

In some implementations, the initiation process, appliance 10, and/or system 1, or portions thereof, may include at least one control knob 20, 120 that is positioned between a first configuration and a second configuration. A knob body 21, shaft bracket 21b, and/or knob 20, 120 (e.g. first portion 20a) may be positionable between the first and second configuration relative to a collar 22, actuator 16, second portion 20b, panel 11, knob shaft 24, and/or longitudinal/rotational axis A. In the first configuration as shown in FIGS. 2-4, 8A-9B, 11, 12, and 14, the control knob 20, 120 may not activate (e.g. push and turn) the actuator 16 or control/gas valve 17 to operate the heating element(s) 15. For example, the knob 20, 120, valve 17, actuator 16, and/or heating element 15 is locked or the safety feature/system 1 is engaged. In the second configuration as shown in FIGS. 5, 6, 10A, 10B, 15, and 16, the control knob 20, 120 may activate (e.g. push and turn) the actuator 16 or control/gas valve 17 to operate the heating element(s) 15. When in the second configuration as shown in the one embodiment, the knob 20, 120 may allow for the push and turn of the actuator 16 or gas valve 17. For example, the knob 20, valve 17, actuator 16, and/or heating element 15 is unlocked or the safety feature/system 1 is disengaged. In the first configuration, the control knob 20, 120 (e.g. body, portion(s), shaft bracket 21b) may not be rotated and/or axially moved (e.g. in the first direction D1) relative to the control panel 11, actuator 16, valve 17, collar 22, if used, longitudinal/rotational axis A, and/or appliance 10, or portions thereof. In the first or locked configuration, the control knob 20, 120 may not be pressed or pushed (e.g. along a longitudinal axis, first direction, along longitudinal axis of the gas valve/shaft, axially) to allow axial movement of the actuator 16 (e.g. shaft 17a, valve), or portions thereof, or in a direction against the biased shaft 17a of the valve 17. Further in the first configuration, the knob 20 (e.g. body 21, portion 20a, shaft bracket 21b) may not axially move towards the second portion 20b or collar 22, if used, or control panel 11 (e.g. along the longitudinal axis A). Further in the first or locked configuration, the control knob 20, 120 may not be rotated (e.g. about a longitudinal axis, about longitudinal/rotational axis A of the gas valve/shaft, clockwise, counter-clockwise, at least one rotational direction) to allow rotational movement of the actuator 16 (e.g. valve 17, shaft 17a), or portions thereof, or in a rotational direction about the shaft 17a of the valve. Further in the first configuration, the knob 20, 120 (e.g. body 21, portion 20a, shaft bracket 21b) may not rotate relative to the second portion 20b or collar 22, if used, or control panel 11 (e.g. about the rotational/longitudinal axis A). In the second configuration, the control knob 20, 120 (e.g. body, portion(s), knob shaft), or portions thereof, may be rotated and/or axially moved relative to the control panel 11, valve 17, second portion 20b, collar 22, if used, rotational/longitudinal axis A, and/or appliance 10, or portions thereof. In the second or unlocked configuration, the control knob 20, 120, or portions thereof, may be pressed or pushed (e.g. along a longitudinal axis, along rotational/longitudinal axis A of the gas valve/shaft, axially) to allow axial movement of the knob shaft 24 and actuator 16 (e.g. shaft, valve), or portions thereof, or in a direction (e.g. first direction D1) against the biased shaft 17a of the valve 17 (e.g. the push step of activation). Further in the second configuration, the knob 20, 120 (e.g. body 21, first portion) may axially move towards the second portion 20b or collar 22, if used, or control panel 11 (e.g. along the rotational/longitudinal axis A, in the first direction D1). Further in the second or unlocked configuration, the control knob 20, 120 may be rotated (e.g. about a longitudinal axis, about rotational/longitudinal axis A of the gas valve/shaft, clockwise, counter-clockwise, at least one rotational direction) to allow rotational movement of the knob shaft 24 and actuator 16 (e.g. valve, shaft 17a) or in at least one rotational direction about the shaft 17a of the valve (e.g. the turn step of activation). Further in the second configuration, the knob 20, 120 (e.g. body 21, first portion) may rotate relative to the second portion 20b or collar 22, if used, or control panel 11 (e.g. about the rotational/longitudinal axis A).

In some implementations, one or more locking mechanisms 30 may be operably engage the control knob 20, 120 with the actuator 16 or knob shaft 24. The locking mechanism 30 may be unlocked or disengaged in the first configuration and lock or engaged in the second configuration. The locking mechanism 30 may include one or more protrusions 21a (e.g. ribs) releasably engaging one or more latching docks 22b. When in the first configuration as shown in FIGS. 2-4, 8A-9B, 11, 12, and 14, the ribs 21a are disengaged from the one or more latching docks 22b. When in the second configuration as shown in FIGS. 5, 6, 10A, 10B, 15, and 16, the ribs 21a are engaged from the one or more latching docks 22b. When in the second or locked configuration, the ribs 21a lock or engage to the latching docks 22b allowing the control knob 20, 120 (e.g. body, shaft bracket, both) to move (e.g. push and turn, rotate, axially) the knob shaft 24 and/or push and turn actuator 16 (e.g. in a first direction) to activate the heating elements 15. When in the first or unlocked configuration, the ribs 21a of the control knob 20, 120, or portions thereof, are disengaged from the latching docks 22b not allowing the control knob to move (e.g. push and turn, rotate, axially) the knob shaft 24 and/or push and turn actuator 16 (e.g. in a first direction) to activate the heating elements 15.

In some implementations, the system 1, control knob 20, 120, valve 17, control panel 11, and/or appliance 10, or portions thereof, may include a biasing mechanism 23. The biasing mechanism 23 may urge rotational relative movement, longitudinal movement, or both between one or more structures of the control knob 20, 120 and/or appliance/actuator/knob shaft. The bias mechanism 23 may be coupled between the knob shaft 24 and the control knob 20, 120 (e.g. body, shaft bracket). The biasing mechanism 23, if used, may urge (e.g. slide) the portion(s) (e.g. first portion 20a, knob body 21, shaft bracket 21b, rib 21a) of the control knob 20 in a first direction D1 (e.g. axially, along the longitudinal/rotational axis A) towards the actuator 16, valve 17, shaft 17a, portions 20b, latching docks 22b, control panel 11, slots 22a, proximal/first end 25b of the slot 122a, collar 22, if used, and/or portions of the appliance. When in the first configuration, the biasing mechanism 23 may urge the knob 20, 120, shaft bracket 21b, and/or ribs 21a in the first direction D1, away from the second configuration, away from the knob shaft 24 and/or latching docks 22b, towards the proximal/first end 25b of the slot 122a, ribs 21a out of engagement with the latching docks 22b, ribs 21a into or axially into engagement with the axial slots 22a, and/or towards the push and turn actuator 16. When in the second configuration, the biasing mechanism 23 may urge the knob 20, 120, shaft bracket 21b, and/or ribs 21a in the first direction D1, the ribs 21a into engagement with the latching docks 22b, towards the distal/first end 25b of the slot 122a, towards or into engagement with the ledge 22ba, and/or towards the push and turn actuator 16. The biasing mechanism may urge the control knob, or portions thereof, towards the actuator or other portions of control knob/appliance in both the first and second configurations. The biasing mechanism 23 (e.g. rotational spring 23b) may urge the control knob 120, shaft bracket 21b, ribs 21a, and/or body 21 rotationally and/or axially about the longitudinal/rotational axis A (e.g. in a second rotational direction, opposite to the first rotational direction or turning direction of the actuator, circumferentially, at least one rotational direction) relative to the knob shaft 24, slot 122a, and/or latching dock 22b. The biasing mechanism 23 may be one or more springs as shown in the one embodiment, however the biasing mechanism may be a variety of shapes, sizes, positions, quantities, and constructions and still be within the scope of the invention. The biasing mechanism 23 as shown in the one embodiment in FIGS. 1, 11-16 may be a rotational or torsion spring 23b. The rotational spring 23b or mechanism 23 may rotationally and/or axially bias structures relative to each other. The biasing mechanism 23 as shown in the one embodiment in FIGS. 1-10 may be an axial or helical coil spring 23a. The rotation of the control knob 20, 120 (e.g. counterclockwise) back to the off position of the valve 17 allows the biasing mechanism 23 to move the control knob 20, or portions thereof, to the first/home configuration or away from the second configuration. The biasing mechanism 23 may be positioned between the knob shaft 24, if used, and the control knob 20, 120 (e.g. knob body 21, shaft bracket 21b). In the embodiment shown, the biasing mechanism 23 is between the shaft bracket 21b and the knob shaft 24.

In some implementations, the system 1, control knob 20, control panel 11, and/or appliance 10 may include one or more locking rings or collars 22 or second portion(s) 20b. The collar 22 may be at least a portion of the second portion 20b. The collar(s) 22 (e.g. through opening), if used, may define the rotational/longitudinal axis A. The collar 22 may be fixed (e.g. rotationally, axially, both) relative to the actuator 16 (e.g. push and turn, valve 17), control panel 11, or appliance 10. The collar 22 may be coupled to the knob body 21. The collar 22 may be fixed in position relative to the knob body 21, knob shaft 24, and/or shaft bracket 21b (e.g. when assembled to the appliance). The knob body 21 or first portion 20a may move between the first configuration and the second configuration relative to the collar 22 or second portion 20b.

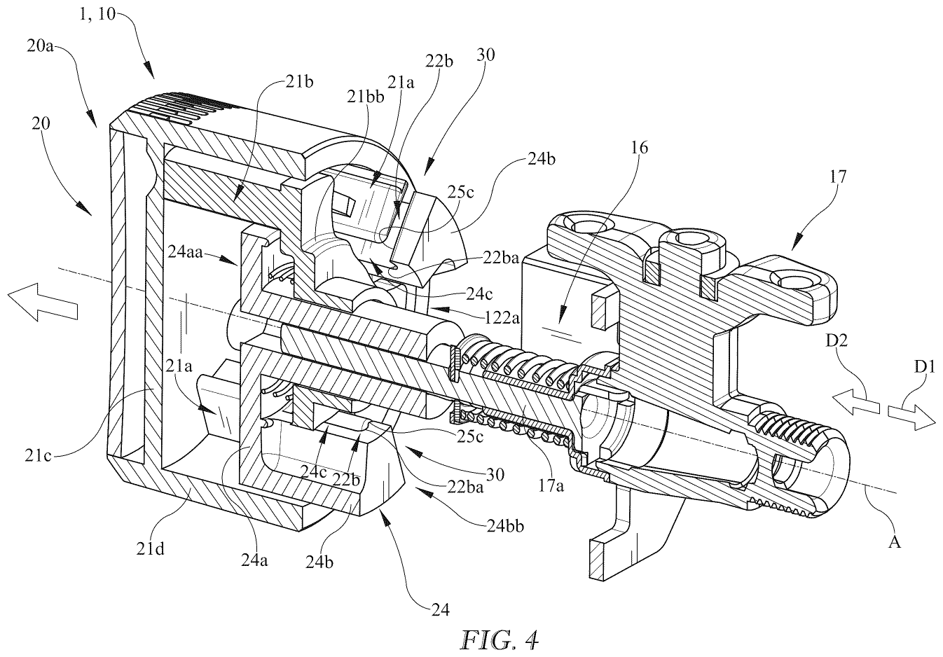

In some implementations, the system 1, knob 20, control panel 11, and/or appliance 10, or portions thereof, may include one or more locking structures or mechanisms 130 engaging therebetween in a third configuration and disengaging therebetween in the fourth configuration. The locking structure 130 may be an interface or releasable engagement between portions (e.g. 20a, 20b, etc.) of the knob 20 and/or between portions of the knob 20 and the control panel 11/actuator 16/appliance 10, or portions thereof. In one embodiment, the locking structure 130 may include rib(s) 21a operably engaging notches/slots/though openings 22a (e.g. axial). In the one embodiment shown in FIGS. 1-10, the control knob 20, or portions thereof, (e.g. body) may include one or more ribs 21a engaging one or more slots 22a (e.g. axial). The one or more ribs may be axially projecting ribs 21a axially engaging the one or more axial slots 22a. The collar 22 or second portion 20b may include one or more slots 22a and the knob body 21 or first portion 20a may include one or more ribs 21a. Alternatively stated, the axial slots 22a, if used, may be separate from or not included in the knob shaft 24. When in the third configuration as shown in FIGS. 2, 3, 8A, and 8B, the one or more ribs 21a engage (e.g. axially) the one or more slots 22a. In the third configuration, the rib(s) 21a and corresponding knob 20 structure (e.g. body 21, first portion 20a) may not rotate relative to the engaged slots 22a and correspondence knob 20 structure (e.g. collar 22, second portion 20b). When in the fourth configuration as shown in FIGS. 4, 5, 6, and 9A-10B, the one or more ribs 21a are disengaged (e.g. axially) from the one or more slots 22a. In the fourth configuration, the rib(s) 21a and corresponding knob 20 structure (e.g. body 21, first portion 20a) may axially move relative to the engaged slots 22a and correspondence knob 20 structure (e.g. collar 22, second portion 20b). The collar 22 may have a skirt 22c projecting from a bottom wall 22d. The bottom wall 22d may contain at least one slot 22a. The knob body 21 (e.g. shaft bracket 21b) may include the one or more ribs 21a. The one or more ribs 21a may face or project towards the control panel 11, skirt 22c, valve 17, and/or collar 22. The knob body 21 may have a shaft bracket 21b of the knob body 21 opposite from the distal free end. The distal fee end or body 21 and the shaft bracket 21b straddle the knob shaft 24, if used, of the knob 20. The distal free end of the knob body 21 may be adjacent the front side of the knob shaft 24 (e.g. proximal the user) and the shaft bracket 21b may be adjacent the back side of the knob shaft 24 or control panel 11. The knob body 21 (e.g. rear facing, proximal end opposite to the distal free end, within body skirt) may include the plurality of ribs 21a. The ribs may project from the inside or rear face of the knob body 21. The knob shaft 24 engages the shaft 17a of the valve 17 or actuator 16. The rib(s) 21a (e.g. single) may axially disengage/engage the slots 22a between the third and fourth configurations or when in the first configuration. Although not shown, in some embodiments where a collar is not used, the control panel 11 or remaining portion of the appliance may include or define the one or more slots (e.g. axial).

In some implementations, the control knob 20, 120, knob shaft 24, and/or appliance 10 includes one or more latching docks 22b. In the embodiments shown, the knob shaft 24 includes the one or more latching docks 22b. As shown in FIGS. 1-10, the knob shaft 24 includes a plurality of skirt members 24b separated by or spaced by slots/gaps 122a (e.g. longitudinal). The skirt members 24b project towards the first direction D1 from a front wall 24a adjacent the front end 24aa. One or more skirt members 24b may include a circumferential or lateral edge 24c defining the latching dock 22b between adjacent members 24b. The latching dock 22b includes a ledge/flange/surface 22ba facing the second direction D2 and/or connected to the slot 122a. The ledge 22ba or latching dock 22b may extend or project circumferentially from the lateral edge 24c of the skirt member 24b. The ledge 22ba prevents axially movement of the rib 21a (e.g. axial, radial) and corresponding knob movement in the first direction D1 when the latching dock 22b and rib 21a (e.g. distal free end) engage in the second configuration. The ledge 22ba may be positioned between the rib 21a and the collar/panel/actuator, may be more distal in the first direction D1 than the rib 21a, and/or interfere with axial travel in the first direction D1 when in the second configuration. The ledge 22ba may be spaced from the distal free end of the skirt member 24b or rear end 24bb. The ledge 22ba (e.g. surface) may face opposite (e.g. towards the second direction) the distal free end of the skirt member 24b. When the knob 20 and rib 21a (e.g. axially projecting rib from the control body) axially passes (e.g. in the second direction D2) through the slot 122a between members 24b from the first configuration towards the second configuration, the turn/rotation of the knob 20 engages the rib 21a with the ledge 22ba or dock 22b to the second configuration. A rotation or turn in the other rotational direction may separate the rib 21a from the ledge 22ba or latching dock 22b towards the first or home configuration. The slots 122a may extend longitudinally along axis A and extend through opposing front end 24aa and rear end 24bb of the knob shaft 24. The longitudinal slots 122a may also be described as extending radially through the inner and outer periphery of the skirt or skirt members 24b in some embodiments. The ledge 22ba may be spaced from both opposing ends 24aa and 24bb of the knob shaft 24.

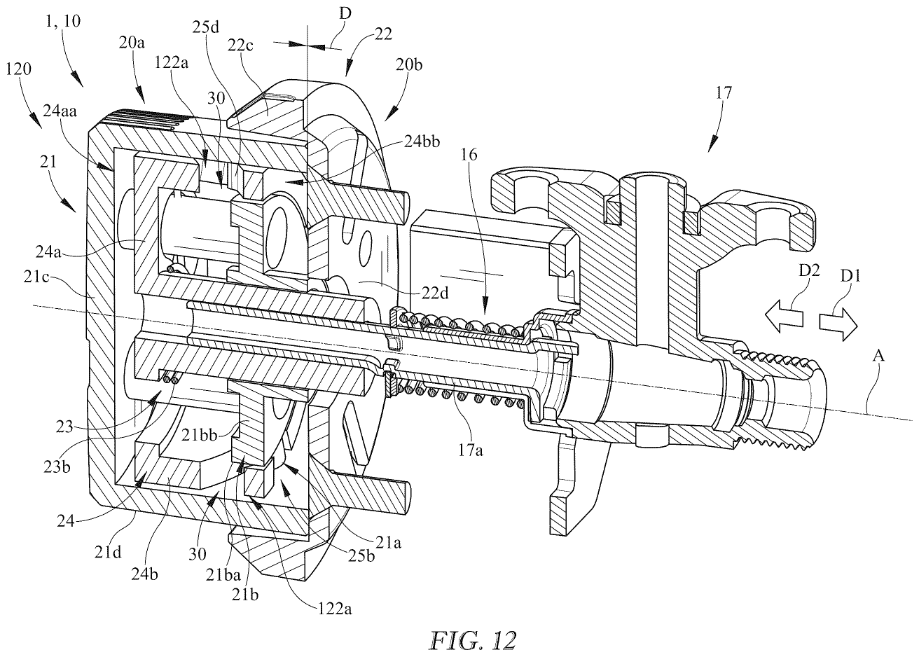

In some implementations, the control knob 120 and/or knob shaft 24 may include a skirt member 24b (e.g. single) may include or define one or more slots 122a (e.g. longitudinal). As shown in FIGS. 1 and 11-16, the skirt member 24b projects towards the first direction D1 from the front wall 24a adjacent the front end 24aa. The longitudinal slot 122a may have a first end 25b and an opposing second end 25a. The first end 25b may be adjacent the rear end 24bb and the second end 25a may be spaced from the front end 24aa. The first end 25b may be open or extend through the rear end 24bb of the skirt member 24b. The second end 25a may be closed. The second end 25a may include the latching dock 22b. The longitudinal slot 122a may be helical or arcuate in shape about the rotational/longitudinal axis A. Although the longitudinal slots 122a may be described as extending radially through the inner and outer periphery of the skirt or skirt members 24b as shown, the slots 122a may extend from and through the inner periphery only and not extend radially through the outer periphery of the skirt in some embodiments. As shown in FIGS. 12-16, the second end 25a and/or latching dock 22b may be circumferentially offset and/or longitudinally offset from the first end 25b of the slot 122a. The second end 25a, slot 122a, or latching dock 22b may include or define the ledge/flange/surface/catch 22ba facing the second direction D2 and/or connected to the slot 122a (e.g. second end 25a). The ledge 22ba may prevent axially movement of the rib 21a (e.g. axial, radial, engaged) and corresponding knob 120 movement in the first direction D1 when the latching dock 22b and rib 21a (e.g. distal free end) engage in the second configuration. The radially projecting rib 21a may engage the first end 25b of the longitudinal extending slot 122a when in the first configuration and the opposing second end 25a of the longitudinal extending slot 122a when in the second configuration. The latching dock 22b may be adjacent the opposing second end 25a of the longitudinal slot 122a. When the knob 120 and rib 21a (e.g. radially projecting rib from the shaft bracket 21b) axially passes (e.g. in the second direction D2) along/through the slot 122a, from the first end 25b to the second end 25a, within the skirt 24b from the first configuration towards the second configuration, the turn/rotation of the knob 120 engages the rib 21a with the ledge 22ba or dock 22b in the second configuration. A rotation or turn in the other rotational direction may separate the rib 21a from the ledge 22ba or latching dock 22b towards the first or home configuration or first end 25b. The knob 20, 120, latch dock, and/or slot may include a detent 25c projecting therefrom to maintain/retain the rib 21a engaged to the ledge 22ba in the second configuration. At least a sufficient rotationally force by the user may be used to rotate/separate/overcome the rib 21a from the detent 25c, if used.

In some implementations, the slots 122a, knob shaft 24, control knob 120, and/or appliance 10 may include one or more cam surfaces 25d. The knob shaft 24 and/or slot 122a may include the cam surface(s) 25d. The cam surface 25d, if used, may drive the ribs 21a (e.g. radial projecting) and control knob 120 (e.g. body, shaft bracket) from the first configuration to the second configuration to engage the ribs 21a to the latching docks 22b (e.g. locking mechanism 30). The cam surface 25d may convert the rotatory motion to axially move the control knob 120 in the second direction D1 when rotating the control knob 120 (e.g. body, shaft bracket, rib) relative to the knob shaft 24. The cam surface 25d may raise or move out the control knob 120 away from the control panel 11 or actuator 16, or portions thereof, in the second direction D2 without having to pull the control knob to the second configuration. Alternatively, the user may pull the control knob 120 as well as rotate in some embodiments.

In some implementations, the one or more protrusions 21a or locking mechanism 30, or portions thereof, may include a variety of quantities, shapes, sizes, constructions, and/or positions within the control knob. For example, the protrusions 21a may be one or more ribs, posts, projections, etc. As shown in FIGS. 11-16, the ribs 21a may radially project from the shaft bracket 21b. The ribs 21a may project radially outwardly from the outer periphery 21ba of the shaft bracket 21b. The rib 21a may be cylindrical or arcuate in shape. The ribs 21a may be circumferentially spaced about the outer periphery 21ba. The ribs 21a may project outwardly from outer periphery 21ba of a plate member 21bb. The plate member 21bb may include a through opening to receive (e.g. slidably) the knob shaft 24 and/or valve 17/shaft 17a/actuator 16. The radially projecting ribs 21a may be biased (e.g. rotational biasing mechanism 23b) in a rotational and/or axial direction, away from the latching dock 22b, and/or towards the first configuration or first end 25b of the slot 122a. The bias mechanism 23, 23b may be positioned between the plate member 21bb and the front member 24a and/or between shaft bracket 21b and the knob shaft 24. As shown in FIGS. 2-10, the ribs 21a may axially project from the knob body 21 or control knob 20. The ribs 21a may axially project from the front member 21c of the knob body 21, along the inner periphery of the skirt 21d of the knob body 21, and/or beyond the axial extent of the skirt distal free end in the first direction D1. The ribs 21a may project radially inward from the skirt 21d in some embodiments. The ribs may be a blade or be rectangular in shape.

In some implementations, the knob shaft 24 may be slidably connected to the control knob 120, 20. The shaft bracket 21b and knob body 21 may slidably engage the knob shaft 24 therebetween. The ribs 21a may slidably engage the corresponding slots 22a, 122a. The bias mechanism 23, 23a, 23b may be positioned between the shaft bracket 21b and the knob shaft 24. The control knob 20, 120, or portions thereof, is positionable between the first and second configurations relative to the knob shaft 24, or portions thereof. In the home or first configuration at the furthest axial extent or travel of the control knob 20, 120 in the first direction D1 as shown in FIGS. 2, 3, 8A, 8B, 11, 12, and 14, the distance D between the knob (e.g. body) and collar 22, if used, or control panel 11 is not sufficient (e.g. length of zero, first length/distance) to allow axial knob movement in the first direction D1. As such with insufficient axial clearance (e.g. distance D) in the first direction D1, the user needs to complete the initiation steps of the control knob 20, 120 to overcome the safety feature 1 or unlock. In the second configuration as shown in FIGS. 5, 6, 10A, 10B, 15, and 16, the distance D between the knob (e.g. body) and collar, if used, or control panel is sufficient (e.g. greater than of zero or first length/distance, second length) to allow axial knob movement in the first direction D1 to activate the actuator 16 via push and turn (see FIG. 16).

In some implementations upon initiation of the control knob 20 to the second configuration, the knob shaft 24, actuator 16, and/or valve 17 may be push and turned along the rotational/longitudinal axis A in the first direction D1 to activate the heating element 15 via the control knob 20, 120. In some embodiments, the control knob 20, 120 may include a knob shaft 24. As shown in one embodiment, the knob shaft 24 is rotationally and/axially coupled to the shaft 17a of the actuator 16 or valve 17. When in the first configuration, the knob 20, 120 (e.g. body 21, shaft bracket 21b, ribs) may not rotate and/or axial move the knob shaft 24 and corresponding shaft 17a and/or actuator 16. The knob shaft 24, if used, may not be pushed and turned in the first configuration. When in the second configuration, the knob 20 (e.g. body, shaft bracket, ribs) may rotate and/or axial move (e.g. push and turn) the knob shaft 24 and corresponding shaft 17a and/or actuator 16 to open or activate the heating element(s) 15. In the second configuration, the ribs 21a (e.g. axial, radial) engage the latching docks 22b (e.g. ledge 22ba). As shown in the one embodiment, the knob body 21 and shaft bracket 21b may move together relative to the knob shaft 24 between the first configuration and second configuration. In the second configuration, the knob body 21 and shaft bracket 21b rotate and axially (e.g. push) operate the knob shaft 24 and/or shaft 17a of the push and turn actuator or device 16, relative to the fixed panel 11, collar 22, if used, appliance 10, or portions thereof.

In use, in some implementations, the safety feature/system 1 or initiation steps for activating (e.g. via push and turn) the one or more heating elements 15, appliance 10, or actuator 16 (e.g. valve, switch, etc.) may include operating one or more control knobs 20, 120. The control knob 20, 120 may have initiation steps (e.g. pull, rotate, one, two, one or more) before the valve 17 or actuator 16 may be opened/activated (e.g. via push and turn, other activation steps, one step, two step, three step, etc.) from the closed position. In some embodiments as shown in FIGS. 2, 3, 8A, and 8B, the knob 20 may be in the locked (e.g. rotationally) or third configuration. In the third configuration the locking mechanism 130 may have the rib(s) 21a (e.g. axially projecting ribs) engaged (e.g. axially) to the one or more slots 22a (e.g. axial). In the third configuration, the knob 20 (e.g. body and shaft bracket) may not rotate relative to the control panel 11, knob shaft 24, actuator 16, valve 17, and/or shaft 17a. The user may move the knob 20 (e.g. rotatable, body) in the second direction D2 (e.g. axially, not the first direction) along the longitudinal/rotational axis A of the collar 22, shaft 17a, knob shaft 24, valve 17, and/or actuator 16, or portions thereof. In some embodiments, the moving of the knob 20 to the fourth configuration may include sliding the knob in the second direction D2 (e.g. parallel to the rotational axis A). In the embodiment shown, the user may pull the knob body 21 axially relative to the rotational axis A, control panel 11, and/or appliance 10 to the fourth configuration. When in the unlocked or fourth configuration as shown in FIGS. 4-6 and 9A-10B, the rib(s) 21a may be disengaged from the one or more slots 22a. After the user has moved the rotatable knob 20 from the fourth configuration and/or first configuration (e.g. in the direction D2 axially along and rotate about the rotational/longitudinal axis A) and rotates/engages the ribs 21a with the latching docks 22b in the second configuration, the user may push the knob 20 (e.g. knob body, knob shaft) axially or parallel to the longitudinal axis A in the first direction D1 and/or rotate the knob (e.g. knob body, knob shaft) about the axis A. The rotation of the knob 20 may be to one or more predetermined positions representative of a desired output level of one or more heating elements 15 or actuators 16 (e.g. valve). The method may include biasing (e.g. biasing mechanism) the knob in the first direction D1 along the rotational/longitudinal axis A or towards the locked or second configuration and/or third configuration.

In use, in some implementations, the knob 20, 120 may be in an unlocked or first configuration. In the home or first configuration as shown in FIGS. 2, 3, 8A, 8B, 1, 12, and 14, the shaft may be able to move in a single direction, second direction D2, and/or against a biasing mechanism 23 (e.g. away from the push and turn actuator, towards the second configuration). The biasing mechanism 23 (e.g. 23a, 23b) may bias the knob 20, 120 in the first direction D1 along the rotational/longitudinal axis A and/or rotationally about the longitudinal axis. The biasing mechanism 23a may bias the knob 20 in the first direction D1 along the rotational/longitudinal axis A. The biasing mechanism 23b may bias the knob in the first direction D1 along the rotational/longitudinal axis A and/or rotationally about the longitudinal axis A. When in the home position with distance D unavailable to move the knob 20, 120 in the first direction D1, when the one or more ribs 21a are disengaged from the latching docks 22b, and/or when the rib(s) 21a are engaged to the axial slots 22a, axial movement of the control knob 20, 120 in the first direction D1 may be prevented or reduced. The user may have to pull and/or rotate the control knob 20, 120 in the second direction D2. In some embodiments, the user may only need to rotate the control knob 120 to move the control knob in the second direction D2. The rib 21a may travel (e.g. in one or more directions) through the slots 122a between the first configuration and second configuration. Upon sufficient axial travel in the second direction D2 as shown in FIG. 4, the user may rotate (e.g. in a first rotational direction, at least one rotational direction) the rib 21a or control knob 20, 120 into engagement with the latching dock 22b to the second configuration as shown in FIG. 5. In the second configuration the locking mechanism 30 may have the rib(s) 21a (e.g. axially projecting ribs, radially projecting ribs) engaged (e.g. axially, circumferentially) to the one or more latching docks 22b (e.g. ledge). Once in the second configuration, the user may operate/activate (e.g. push and turn, push in first direction, rotate about axis A, rotate in at least one rotational direction) the push and turn actuator 16 to one or more predetermined positions representative of the desired output level of one or more heating elements. In the second configuration, the ribs 21a may transfer force in the first direction D1 to the latching dock 22b and subsequent knob shaft 24 to activate the actuator 16, or portions thereof.

While a variety of inventive embodiments have been described and illustrated herein, those of ordinary skill in the art will understand that a variety of other methods, systems, and/or structures for performing the function and/or obtaining the results, and/or one or more of the advantages described herein are possible, and further understand that each of such variations and/or modifications is within the scope of the inventive embodiments described herein. Those skilled in the art will understand that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

What is claimed is:

1. A cooking appliance comprising:
one or more heating elements;
a push and turn actuator configured to operate the one or more heating elements;
a control knob includes one or more protrusions;
a knob shaft slidably connected to the control knob, wherein the knob shaft includes one or more latching docks;
a biasing mechanism between the knob shaft and the control knob;
wherein the control knob is positionable between a first configuration and a second configuration relative to the knob shaft, wherein when in the first configuration the one or more protrusions are disengaged from the one or more latching docks whereby the biasing mechanism urges the control knob and the one or more protrusions in a first direction along a longitudinal axis away from the knob shaft and one or more latching docks towards the push and turn actuator, and wherein when in the second configuration the one or more protrusions are engaged to the one or more latching docks whereby the biasing mechanism urges the one or more protrusions in the first direction into engagement with the one or more latching docks towards the push and turn actuator; and
when in the second configuration the control knob is configured to push the knob shaft and push and turn actuator in the first direction and rotate the knob shaft and push and turn actuator in at least one rotational direction about the longitudinal axis.

2. The cooking appliance of claim 1 wherein the one or more protrusions are an axially projecting rib axially engaging one or more axial slots in a third configuration and axially disengaging the one or more axial slots in a fourth configuration.

3. The cooking appliance of claim 2 wherein the control knob includes a collar, wherein the collar includes the one or more axial slots.

4. The cooking appliance of claim 1 wherein the one or more protrusions are a radially projecting rib radially engaging a first end of one or more longitudinal extending slots when in the first configuration and an opposing second end of the one or more longitudinal extending slots when in the second configuration, and wherein the one or more latching docks is adjacent the opposing second end of the one or more longitudinal extending slots.

5. The cooking appliance of claim 4 wherein the knob shaft includes the one or more longitudinal extending slots.

6. The cooking appliance of claim 4 wherein the one or more longitudinal extending slots are helical in shape about the longitudinal axis.

7. The cooking appliance of claim 1 wherein the biasing mechanism urges the control knob rotationally about the longitudinal axis.

8. The cooking appliance of claim 1 wherein the control knob includes a knob body and a shaft bracket, wherein the knob shaft is slidably positioned between the knob body and the shaft bracket, and wherein the one or more protrusions axially project from the knob body or radially project from the shaft bracket.

9. A control knob for a cooking appliance comprising:
a knob body having one or more protrusions;
a knob shaft having one or more latching docks;
a biasing mechanism between the knob body and the knob shaft;
wherein the knob body is positionable between a first configuration and a second configuration relative to the knob shaft, wherein when in the first configuration the one or more protrusions are disengaged from the one or more latching docks whereby the biasing mechanism urges the knob body and the one or more protrusions in a first direction along a longitudinal axis away from the knob shaft and one or more latching docks, and wherein when in the second configuration the one or more protrusions are engaged to the one or more latching docks whereby the biasing mechanism urges the one or more protrusions in the first direction into engagement with the one or more latching docks; and
when in the second configuration the knob body is configured to push the knob shaft and push and turn actuator in the first direction and rotate the knob shaft and push and turn actuator in at least one rotational direction about the longitudinal axis.

10. The control knob of claim 9 wherein the one or more protrusions are an axially projecting rib axially engaging one or more axial slots in a third configuration and axially disengaging the one or more axial slots in a fourth configuration.

11. The control knob of claim 10 further comprising a collar, wherein the collar includes the one or more axial slots.

12. The control knob of claim 9 wherein the one or more protrusions are a radially projecting rib radially engaging a first end of one or more longitudinal extending slots when in the first configuration and an opposing second end of the one or more longitudinal extending slots when in the second configuration, wherein the one or more latching docks is adjacent the opposing second end of the one or more longitudinal extending slots.

13. The control knob of claim 12 wherein the knob shaft includes the one or more longitudinal extending slots.

14. The control knob of claim 12 wherein the one or more longitudinal extending slots are helical in shape about the longitudinal axis.

15. The control knob of claim 9 wherein the biasing mechanism urges the control knob rotationally about the longitudinal axis.

16. A method of activating one or more heating elements of a cooking appliance comprising the steps of:
providing a push and turn actuator with a knob shaft connected thereto, wherein the knob shaft includes one or more latching docks;
providing a control knob having one or more protrusions;
axially moving the control knob in a second direction along a longitudinal axis away from the push and turn actuator;
rotating the control knob relative to the knob shaft to engage the one or more protrusions of the control knob to the one or more latching docks of the knob shaft; and
pushing in a first direction opposite to the second direction along the longitudinal axis and rotating the control knob and the knob shaft after rotating the control knob to engage the one or more protrusions to the latching docks to operate the push and turn actuator to a predetermined position representative of a desired output level of one or more heating elements.

17. The method of claim 16 converting rotatory motion to axially move the control knob in the second direction wherein rotating the control knob relative to the knob shaft.

18. The method of claim 16 further comprising axially disengaging one or more axially projecting ribs from one or more axial slots when axially moving the control knob in the second direction.

19. The method of claim 16 further comprising preventing axially movement of the control knob in the first direction when the one or more protrusions are disengaged from the one or more latching docks.

20. The method of claim 16 further comprising biasing the control knob in first second direction along the longitudinal axis and/or rotationally about the longitudinal axis.
